(19) United States
(12) Patent Application Publication
(10) Pub. No.: US 2005/0127697 A1
(43) Pub. Date: Jun. 16, 2005

(54) Emergency mobile sleep units

(76) Inventor: C. Glen Berry, Bentonville, AR (US)

Correspondence Address: Theresa M. Seal;C/O The Inventor's Network, Inc., 332 Academy Street, Carnegie, PA, 15106, US

(21) Appl. No.: 10/731,388

(22) Filed: Dec. 10, 2003

(51) Int. Cl. B60P 3/00

(52) U.S. Cl. 296/24.3

(57) ABSTRACT

A mobile sleeping unit transportable from site to site by tractor-trailer, railway, airlift, or by water includes a tractor-trailer unit modified to create a sleeping unit for a number of individuals. The sleeping unit can be in a number of different configurations that includes sleeping bunks attachable to a sidewall of the unit for opening up the interior of the unit when the bunks are not in use, and a storage/kitchen area that can include storage drawers, a countertop, a refrigerator, a microwave oven, wall-hung storage cabinets, water coolers, and other common food preparation items.

### FIELD OF THE INVENTION

The present invention pertains to mobile sleeping units, and more particularly pertains to mobile sleeping units that can be transported to the site by roadway, railway, helicopter, ship or airplane.

### BACKGROUND

The invention involves a mobile sleeping unit, designed to provide temporary accommodations for large numbers of people. During emergency situations, it is often necessary to provide for displaced persons and for emergency workers. For example, during a large forest fire, it is necessary to bring in hundreds of firefighters and other emergency personnel. These persons may be on duty for many days, with little access to adequate shelter, food and sleeping facilities. In another example, after a hurricane or tornado, there may be a large number of persons displaced from their homes. In addition, there will be Red Cross and other emergency aid people brought in to provide assistance. In many areas, there is simply not enough hotels or other accommodations available to house these people.

Currently, shelter during emergencies must be provided by hotels, tens or prefabricated buildings, constructed on-site. These have obvious disadvantages. Existing accommodations, such as hotels, may be nonexistent or too far away. Tents do not provide a significant shelter from weather or extreme temperatures. Prefabricated buildings, such as those disclosed in U.S. Pat. No. 4,603,518, have been used. However, these types of structures are not very portable, and can be expensive to move and set up. Other types of mobile accommodations are available, in the form of recreational vehicles, buses and campers. These types of systems have been described in the prior art, notably U.S. Pat. Nos. 2,231,822, 4,759,582 and 6,017,080. However, these accommodations are not suitable to emergency use because they are typically not designed for off-road or heavy-duty usage.

A better solution would be low cost housing which can be easily moved by truck, helicopter or other means, provides significant protection from weather, has heating and air conditioning, and provides kitchen facilities integrated with the sleeping facilities.

### SUMMARY OF THE INVENTION

In one embodiment, the present invention is directed to a mobile sleeping unit with a vehicle chassis and body. The chassis includes a coupling device to attach to a towing vehicle and wheels to move the unit along roads. The body includes an access door, sleeping bunks, kitchen and storage facilities, lighting ventilation and electricity.

In another embodiment, the present invention is directed to a mobile sleeping unit in which the unit is constructed from a standard 28-foot tractor-trailer.

### BRIEF DESCRIPTION OF THE DRAWINGS

FIG. 1 is a side elevational view of one embodiment of the present invention, attached to a tractor-trailer truck for transportation.

FIG. 2 is a cut view of the inside front portion of the embodiment shown in FIG. 1, showing the kitchen and storage facilities, and the air conditioning unit.

FIG. 3 is a cut view of the inside sidewall of the embodiment shown in FIG. 1, showing the sleeping quarters.

FIG. 4 is a perspective view of the embodiment shown in FIG. 1.

### DETAILED DESCRIPTION

The present invention is directed to a mobile sleeping unit. In the embodiment shown on the figures, the invention utilizes readily available vehicles and equipment to create a unit that can be easily transported and set up in practically any location. The unit can be towed by a tractor trailer truck, or transported by rail or air to any location.

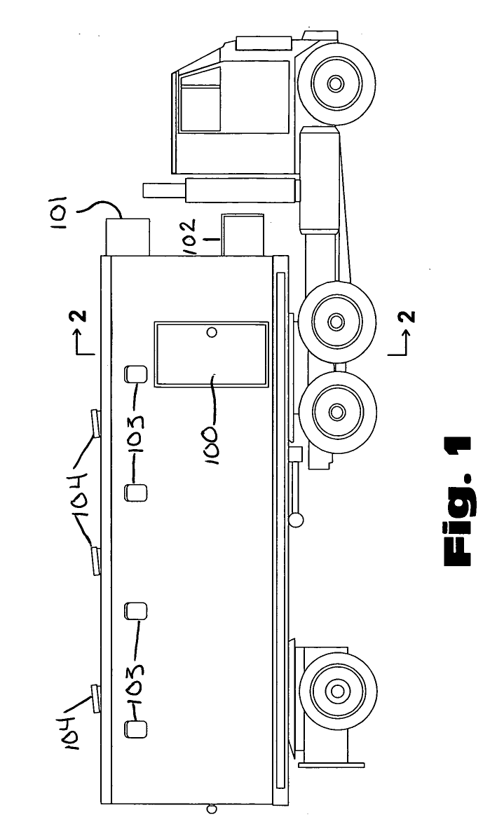

The side view of FIG. 1 shows a standard 28-foot tractor-trailer attached to Class 7 tractor. In this embodiment, a standard tractor-trailer unit is modified to create the mobile sleeping unit. The exterior modifications include an entrance door 100, an air conditioner 101, a generator 102, side windows 103 and roof ventilation/lighting units 104. The generator could be powered by gasoline and could be used to supply electricity for the air conditioning unit, power for electric heaters, power to the refrigerator and cooking appliances and power for lighting. In addition, the generator can be used for recharging emergency equipment such as lights and radios, if the mobile sleeping unit is being utilized for emergency operations, such as a forest fire.

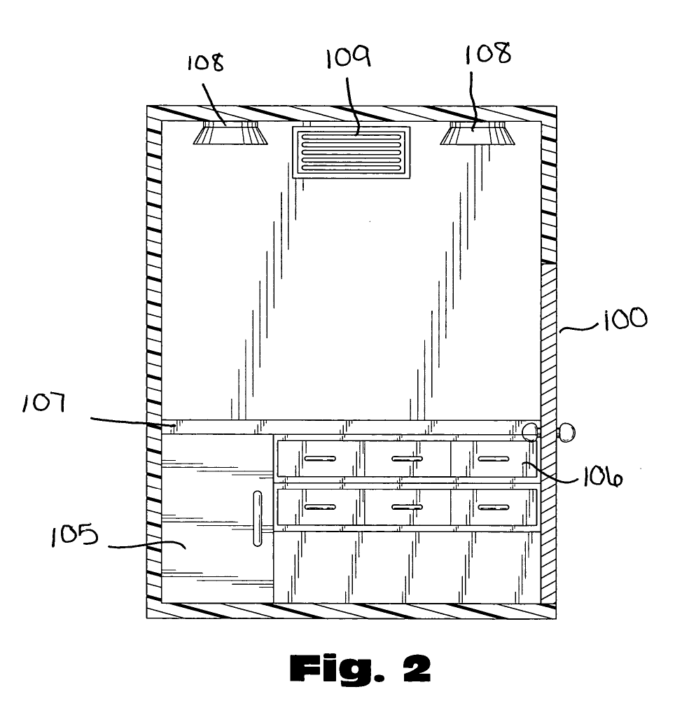

FIG. 2 shows a food storage/kitchen area of the embodiment shown in FIG. 1. In this configuration, the storage/kitchen area is located along the front wall of the interior of the tractor-trailer. A variety of different configurations may be utilized for this area, but in the embodiment shown, the storage/kitchen area includes a refrigerator 105 and storage drawers 106 and a countertop 107. Also shown on FIG. 2 are overhead fluorescent lights 108, an air conditioning vent 109 and the entrance door 100. Other possible configurations for the storage/kitchen area could include water coolers, wall-hung storage cabinets, electrical outlets, microwave ovens, and other common food preparation items.

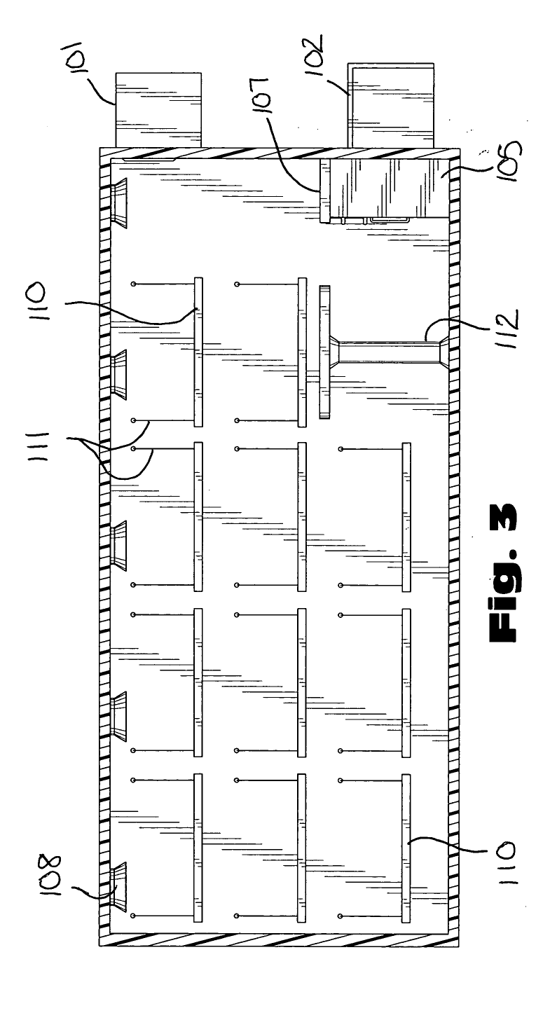

FIG. 3 shows an interior side view of the embodiment shown in FIG. 1. FIG. 3 shows one possible layout for the sleeping bunks. In this embodiment, the sleeping bunks 110 would be attached to the sidewall of the unit, efficiently utilizing the available space. The bunks are attached on one side to the trailer wall, and supported on the other side by cables 111 which attach to the trailer wall. The side of the bunk attached to the trailer wall is hinged, allowing the bunk to be lifted up and placed flat against the wall. This opens up the interior of the unit during daylight hours, allowing the unit to be used as a changing area, command base, lunchroom or rest area. In a standard 28-foot tractor-trailer, four columns of bunks could be placed along the wall, with up to three bunks in each column. The bunks can be placed along each sidewall of the trailer, giving a total of 24 bunks. In the embodiment shown in FIG. 3, one bunk on each sidewall has been removed in order to allow for the addition of a small table 112. The table could be utilized for meals, meetings or as a place to reviews maps and drawings.

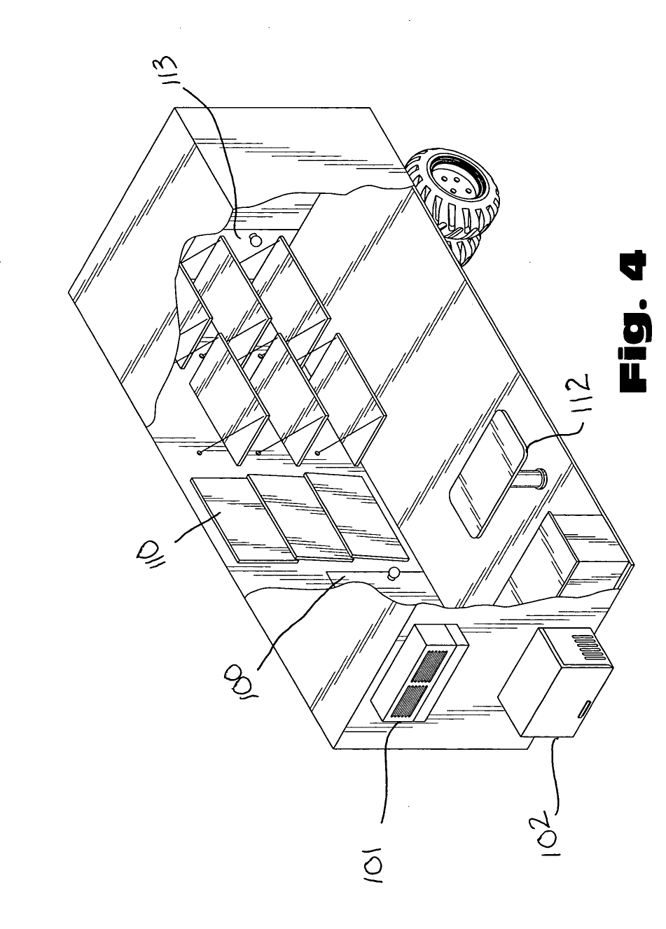

FIG. 4 shows a perspective view of the mobile sleeping unit, with roof being left off for reasons of clarity. This figure shows how the sleeping bunks 110 may be raised and secured to sidewall to open up space in the unit. In the embodiment shown in FIG. 4, the mobile sleeping unit would have three columns of bunk beds on the back wall with three beds in each column. Additional columns of beds would be on the opposite wall of the unit (not shown). The embodiment shown in FIG. 4 also shows a rear entrance door 113, similar to the side entrance door 100, shown in both FIGS. 1 and 4. The rear entrance door is not required, and a standard door for a 28-foot tractor-trailer could be utilized. If a standard door is used, the sleeping unit could more easily be used as a transport unit, to move equipment and supplies to the emergency site. The equipment and supplies could then be removed, allowing use of the unit as a sleeping unit.

Having thus described certain embodiments of the present invention, various alterations, modifications and improvements will be apparent to those of ordinary skill in the art. The alterations, modifications and improvements are intended to be within the spirit and scope of the present invention. Accordingly, the above descriptions are only intended as examples, and are not intended to be limiting.

1-5. (canceled)

6. A mobile sleeping unit comprising a vehicle chassis having a coupling means at one end adapted to be connected to a towing vehicle, supporting wheels on the underside of the chassis and a body mounted on the upper side of the chassis, the body having a front and back side, a top and bottom side and a left and right side forming an enclosed living chamber, the chamber having a floor, a ceiling, a front and back wall and two side walls, a door located on one side wall, a plurality of sleeping bunks pivotally connected to the side walls, a kitchen compartment extending along the front side, the kitchen compartment comprising a table, a refrigerator and storage cabinets, an electricity generation means, a ventilation means and a lighting means.

7. The mobile sleeping unit according to claim 6 in which the vehicle chassis and the body are one unit, the unit consisting of a 28-foot tractor-trailer.

8. The mobile sleeping unit according to claim 7 in which the electricity generation means consists of a fossil fuel powered generator, located at the front side of the body.

9. The mobile sleeping unit according to claim 8 in which the ventilation means consists of an air-conditioning unit and an electric heater.

10. The mobile sleeping unit according to claim 9 in which the lighting means consists of fluorescent lighting fixtures.
